(19) United States
(12) Patent Application Publication
(10) Pub. No.: US 2006/0260753 A1
(43) Pub. Date: Nov. 23, 2006

(54) System for preparing prime label pressure sensitive intermediate laminates

(75) Inventor: Jesse D. Crum, Fort Scott, KS (US)

Correspondence Address: WARD/KRAFT, INC., 2401 COOPER STREET, P. O. BOX 938, FT. SCOTT, KS, 66701, US

(73) Assignee: Ward/Kraft

(21) Appl. No.: 11/135,179

(22) Filed: May 23, 2005

(51) Int. Cl. B32B 38/04; B32B 38/14; B32B 37/22; B32B 41/00; B32B 37/00

(52) U.S. Cl. 156/387; 156/519; 156/552; 156/388; 156/510; 156/362; 156/390

(57) ABSTRACT

The present invention is in the field of composite manufacturing systems that are used in the preparation of articles, namely pressure sensitive laminates such as prime labels and tags. The system of the instant specification includes a computer for creating a file, an image generation means for rendering typically a graphical depiction on one or more surfaces of a substrate, an inserter for placing ribbon or label segments and a web processing apparatus. The labels of the present invention are produced in part, initially from a pre-imaged or printed sheet that are then converted or merged to a roll type of format. The sheets are printed with high quality graphics or images which are then slit or cut to size to form ribbons or label segments for the prime label application and then are converted to or merged with a continuously advancing web to create a continuous roll format. Then the label segments that have been affixed to the web are provided in one or more intermediate configurations to an end user typically for application to consumer packaged goods. More particularly, the pressure sensitive laminates of the instant application can be used to create individual, prime labels having a high or photo quality resolution level such as those about 300 lines per inch or approximately 2500 to 3500 dots per inch.

### CROSS-REFERENCES TO RELATED APPLICATIONS

None.

### FIELD OF THE INVENTION

The present invention is in the field of composite manufacturing systems that are used in the preparation of articles, namely pressure sensitive laminates such as prime labels and tags. The system of the instant specification includes a computer for creating a file, an image generation means for rendering typically a graphical depiction on one or more surfaces of a substrate, an inserter for placing ribbon or label segments and a web processing apparatus. The labels of the present invention are produced in part, initially from a pre-imaged or printed sheet that are then converted or merged to a roll type of format. The sheets are printed with high quality graphics or images which are then slit or cut to size to form ribbons or label segments for the prime label application and then are converted to or merged with a continuously advancing web to create a continuous roll format. Then the label segments that have been affixed to the web are provided in one or more intermediate configurations to an end user typically for application to consumer packaged goods. More particularly, the pressure sensitive laminates of the instant application can be used to create individual, prime labels having a high or photo quality resolution level such as those about 300 lines per inch or approximately 2500 to 3500 dots per inch.

### BACKGROUND OF THE INVENTION

Today, there are wide varieties of product offerings available that serve multiple purposes and functions, including product offerings that are used in fulfilling needs in the prime label market. Conventional processes that are used today in creating prime labels are typically based on a continuous web technology using flexographic presses. The process includes the feeding of a continuous web of material, such as a preformed web of pressure sensitive laminate which normally consists of a top ply having a layer of adhesive on its underside that is covered by a release liner to form the laminate assembly through the press. The web is then processed through a press, typically a flexographic press, and an image is applied to the web by various stations. The web may then be collected, die-cut and the individual labels removed and applied.

Flexography is commonly used today for the printing of decorative items including the rendering of packaging and employs a series of plates and one or more stations, containing inks, to apply colored images to the web as the web traverses the press. Through improvements in ink qualities and other modifications and enhancements in the technology, the image quality in flexographic presses and resulting products has improved to about 150 lines per inch.

For a point of reference, typically, screens that have rulings of between 60 to 100 lines per inch are normally used to make halftone printed images for newspapers. Screens with about 120 to 150 lines per inch are commonly used today to produce images for magazines and commercial printing. Such screens are regularly produced by electronic dot generation.

Electronic dot generation is normally performed by computers that use unique screening algorithms in cooperation with electronic scanners and image setters to produce halftone images that are to be subsequently used to render an image. The pixels of digitized images are first assembled into dots that are then used to form shapes, sizes, rulings, etc. which create the ultimate image produced on the substrate.

While flexographic technology or flexography is desirable for use in such printing due to the economies that can be achieved when compared with other types of printing processes, such as lithography, there are a number of drawbacks in utilizing this process for certain applications. Initially, the quality is limited, despite improvements in the technology to about 150 lines per inch. This can make some complicated graphics appear “grainy” or other images, such as those that use flesh tones or deep or rich colors, look faded or “washed out”. The effects of this level of image resolution can detract from the product appearance which may diminish the value of the technology and the products produced particularly for the prime label market. With increasing sophistication of consumers, as well as technology and expectations from each, such effects may be undesirable to potential end users.

Flexography also suffers from other drawbacks, such as the time involved in preparing a job to run or “make ready” as it may otherwise be known. That is, the steps that are used to prepare the flexography equipment for running a particular job or order. This make ready includes such activity as the preparation of multiple plates to produce the image at each station, mixing inks, calibration and alignment of the images between stations and the like. Operation of the flexography presses may also include multiple operators which can add to manufacturing costs. In addition, waste can also be a problem with such conventional printing technologies in that a number of feet, yards or meters of web material must be processed through the press in order to have the colors reach a predetermined threshold and to ensure appropriate registry of the stations as they are printing the images on the web. The amount of material wasted can be several times the length of the press or up to several hundred feet of material. The use of such volumes of materials obviously increases the cost of the operation. Thus, due to the make ready and waste factors, the production of products, such as prime labels, using flexography may then be limited to serving only certain market segments, namely large market segments. Markets that are applicable for this technology segment are generally believed to be those orders for large quantities of several hundred thousand or millions of pieces, which potentially leaves the smaller label market, e.g. 100 to 1,000,000 labels, unfulfilled or at least not adequately served by currently available technologies due to cost and materials thresholds.

Another drawback believed to be associated with flexographic technologies is that the technology cannot provide any variability in the product, including such basic functionality as sequential numbering, addressing or adding promotional text in connection with a seasonal advertisement or other offering without the addition of further processing stations. If such features are required by an end user or customer, such as with product date or coding, this function generally cannot be performed by flexographic presses without the inclusion of additional stations and instead typically must occur through an off line operation, such as ink jetting, often after the label has been applied to the container or carton. Alternatively, the ink jetting may be performed directly on the container as part of a separate operation.

Flexographic presses normally have a number of pre-determined stations, for example a four color press may have only four stations that can be used to treat or process the web. Thus, if other stations are to be added, such as a numbering head, the manufacturer likely then has to reduce the number of colors that can be added to the web as one station has been surrendered for the numbering head.

Flexographic technology also limits the ability to add personalization to products produced on such presses. This may be particularly desirable in certain market segments such prime label products on consumer package goods (“CPG”) which may further enhance the product or service offering by making the product more attractive to prospective purchasers, thereby increasing the appeal to the consumer of the product or service.

Identifiers such as labels or tags may also be readily rendered using desktop equipment. While the resolution may be slightly improved when compared with conventional flexographic technology, speeds of application are significantly reduced as the images are processed in a sheet wise fashion on desktop equipment resulting in only a few sheets per minute as opposed to hundreds of feet per minute that are capable of being processed by flexographic equipment. That is, the desktop unit may only handle and print one sheet at a time before the next sheet is advanced for printing or imaging when compared with a conventional web fed process. Thus, in using such a desktop process one may only be able to render a handful of sheets per minute as opposed to a flexography operation that may process several hundred feet per minute. Use of desktop processes is thus not likely efficient in trying to generate hundreds and certainly not thousands of labels, but may be useful in creating a few dozen labels for very small applications such as a small home or small office environment.

What is needed therefore is a system by which high quality graphics for prime label applications, in excess of about 150 lines per inch, can be produced in an efficient and cost effective manner, such as in a continuous system operating at greater than fifty feet per minute. Moreover, a system which can add substantial variability to the product as well as other features, such as embossments, over laminates, variable printing or imaging and the like, would greatly expand the penetration of this form of business communication in the marketplace. The present invention seeks to provide a prime label intermediate having a quality of about 150 or more lines per inch and preferably more than 300 lines per inch, which is approximately equal to about 2500 to 3500 dots per inch (“DPI”) in order to create a high quality image that is intended to be aesthetically appealing to the consumer.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Surprisingly, it has been discovered that there is no readily available process or system by which a manufacturer can create high quality prime labels having significantly improved graphic resolution that is greater than about 150 lines per inch, preferably greater than about 200 lines per inch and still more preferably about 300 lines per inch, in an efficient and cost effective manner. The development of the present system, process and the creation of the unique intermediate web assembly described in this invention permit the servicing of a particular niche market segment for prime labels, that of approximately 1000 to 1,000,000 prime labels. While the foregoing market size or segment is a target area of the present invention, it should be appreciated that the invention may be practiced and used to fulfill larger order quantities, such as those of a million labels or more.

The pressure sensitive intermediate of the present invention is created through a unique sheet to roll process which provides savings when compared with conventional flexography process, specifically through reduced make ready time and generation of waste material and yields a higher image resolution product. The present invention uses previously prepared individually created sheets, or segments, that have imaging or printing already applied to the sheets, e.g. graphical depictions, before the sheets are provided to the manufacturing press. The sheets, ribbons or segments may be applied to the web in a number of patterns, including substantially edge-to-edge configuration, with a slight overlap or alternatively, provided in regularly occurring increments depending on the needs of the particular application to be serviced. In addition, the product produced in connection with the present process described in the instant application is also not limited in functionality as a number of materials, operations and options may be used in creating a relatively dynamic product. Such additional processes may include variable printing, embossments, coatings, over laminates and the like.

By preparing the intermediate prime label assembly in the manner described herein, the intermediate web can be processed continuously at speeds of greater than 50 feet per minute, preferably between 75-150 feet per minute and still more preferably at speeds of about 200 feet per minute or greater.

In one exemplary embodiment of the present invention, a system for producing prime label pressure sensitive intermediate web assemblies is described and includes a computer for preparing an image for use in creating a graphical depiction for at least one prime label. An image rendering device is provided in connection with this system for receiving the image from the computer and for generating a pattern to create the image on the at least one prime label. At least one sheet, and preferably a series of sheets, each of which is sized and configured to be processed through the image rendering device. Each of the sheets is capable of being divisible into one or more label segments with at least one segment containing a prime label portion. The segments are then cut from the sheet and are placed into a hopper or feeder for a placer mechanism.

A placer mechanism is also included with the system presently being described. The placer is used for receiving each of the label segments after the sheet is divided into individual segments and will contain a hopper type mechanism to which the segments are inserted. The segments are then removed individually from the hopper by a feeding mechanism which then passes the segments to a cylinder that sequentially deposits the separate segments onto a moving web.

The system also includes a continuous web processing apparatus for handling a continuous substrate. The substrate will typically have a coating of release material and then a pattern of adhesive applied over the release coating. The placer mechanism, upon activation by a sequencer, motor or the like will then sequentially deposit each of the label segments onto the continuous web substrate to create a pressure sensitive intermediate assembly having a series of intermittently laminated label segments.

In a still further embodiment of the present invention, a system for manufacturing an intermittently laminated pressure sensitive label web is described and includes an image rendering device that is used to produce a high quality image on a series of sheets. Each of the sheets is capable of being cut into one or more label ribbons and each of the label ribbons has at least one prime label area.

A continuous web feeding apparatus is used in connection with this system for handling a continuous substrate. The continuous substrate such as a web of cellulosic material has first and second faces, first and second longitudinally extending sides and first and second faces with one of the faces of the substrate coated with a release material. A pattern of adhesive is disposed over the release material.

A placer mechanism is used with the current system and the placer is mounted on the web feeding apparatus. The placer mechanism has a supply of label ribbons and the placer mechanism sequentially places each of the label ribbons over the pattern of adhesive on the continuous substrate in a substantially edge to edge arrangement.

A die cutter is also provided with this system and is disposed downstream from the placer mechanism on the continuous web feeding mechanism. The die cutter is used to create a cut around the prime label area so as to distinguish the prime label area from the remainder of the label ribbon. The label ribbons with the defined prime label portions applied to the continuous web create a prime label intermediate with a number of intermittently laminated label ribbon sections on the continuous web assembly web that may be collected in a continuous format.

In a yet still further exemplary embodiment of the present invention, a system for preparing a continuous pressure sensitive laminate assembly having an edge to edge configuration of prime label segments is described and includes a design platform for creating a graphical design upon request and a rendering device for generating an image on a substrate that has one or more sections capable of receiving the graphical design.

A cutting mechanism is provided in connection with the current system for reducing the substrates into individual sections with each section having at least one prime label portion. A communication array, such as a local area network is used to communicate between the design platform and the rendering device as well as other devices, such as the placer mechanism and web handling apparatus.

The system of the presently described embodiment has a web handling apparatus with a plurality of operating stations. A placer mechanism for serially depositing each of the sections on a continuous web handled by the web handling apparatus occupies one of the stations. The placer mechanism sets the sections intermittently on the web to create an intermittently laminated continuous web. The web is collected by a rewinding device that is located downstream from the web handling apparatus and collects the continuous web with the individual sections disposed thereon in a continuous format such as a roll or fan folded configuration.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a top or surface view of the prime label intermediate web assembly of the present invention showing a series of label segments or ribbons with graphical depictions that vary from one segment to the next;

FIG. 2 depicts a schematic of the system that is used in connection with the practice of the invention; and

FIG. 3 depicts a schematic of the apparatus that is used to carry out the invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

The term “prime label” as used herein refers to a label or other identification piece that may be used interchangeably with labels, such as tags, typically having a pattern of adhesive disposed on one side of a substrate and one or more graphical illustrations or depictions on the opposite side. Some level of textual messaging may also be provided on the face of the label. The adhesive is typically a pressure sensitive adhesive but may also include activatable adhesives such as thermally or moisture sensitive materials. However, it should be understood that all prime labels need not be provided with an adhesive.

Prime labels are further distinguished from other labels in the art in that such labels are known as having a high level of quality or value. The term prime label is often used to describe a type of label that is the highest grade marketed in a particular industry. Prime labels find application in a number of exemplary areas but have found wide range acceptance particularly in the area of consumer packaged goods (“CPG”) and other products for which the prime label is an effective means for communicating a specific message or enhancing the image of the manufacturer or distributor or presenting the product as a high quality item. Prime labels are also used for business communications in that they can convey certain desirable criteria, image, brand recognition or information and can be used independently of a product, such as in connection with advertising a service opportunity or offering, or with other activities or undertakings, such as for example non-profit organizations.

Prime labels, particularly prime labels prepared in accordance with the present invention, may also contain printed messages, including personalized and/or variable information in addition to the graphical displays. The printed messages can be fixed or static, as will be explained herein, may be personalized or sequentially numbered or provided with other unique or special identifiers.

The term “patterns” as used herein refers to strips, lines, shapes, spots, dots, elements and discontinuous segments, as well as regular and irregular placement of such items. Patterns may also refer to combinations of the above-mentioned items such that one pattern may be a continuous strip; another, segmented elements; and a still further an irregular placement of elements or the like. Any combination of patterns is possible depending on the need or application of the manufacturer or the end user. In addition, the pattern can be prepared in order to accommodate a particular theme, season, event, trade dress, graphics, alpha and numeric characters, and the like. Patterns are used in connection with the present invention to describe the placement of the label segments or ribbons applied to the web or individual prime labels positioned on the web in a particular pattern or arrangement. Pattern as defined herein also is used in connection with the adhesive that is applied to the continuous web.

As used herein the term “business communication piece or document” is used to refer to a substrate that, either alone or in combination with other documents can convey a particular message, image or provide information about a particular product or service that is available from the provider of such pieces or documents. Business communication documents or pieces can include advertising, sales and marketing collateral and such other items used to convey information on written or imaged form sheets, brochures, presentation folders, informational sheets and combinations thereof.

The term “personalized information” refers to information that is printed or imaged onto a substrate which is generally variable or unique and which may change from document to document or segment to segment so as to create a customized message or communication for each recipient. Examples of personalized information may include for example names, addresses, descriptions, plans, coding, numbering, promotional text, etc. that may have been acquired from the intended recipient through surveys, questionnaires or answers given to various inquiries generated in response to a request for goods or services.

The term “static or fixed” information refers to printed or imaged information that generally does not change from document to document or segment to segment and may include a general description or body of information about particular products, services, places, etc. that may be of interest to the intended recipient and represents a standard message that the manufacturing or supplier wishes to convey to an end user or customer of the offering.

The term “intermediate” as used herein refers to a product that undergoes one or more processing steps prior to the intermediate reaching a final condition, that of being ready for end use or application. The additional processing steps may include printing, imaging, folding, sealing, separating, cutting, perforating, scoring, adhering and the like. Typically, a product such as with the present invention is provided in an intermediate condition so that a user can add or manipulate the intermediate to create the final or desired end product, such as applying the prime label to a container, carton or the like. Thus, in accordance with the present invention, the intermediate segment for example, could be subject to die cutting, additional printing, such as through ink jetting, over laminating, coating, embossment, and then applied to a container, carton, consumer package good or the like.

The term “sheets” or “segments” as used herein refers to sheets, segments, ribbons, strips, pieces, parts, sections, subdivisions and combinations thereof. The sheet or segment provided as an example for the purposes of this specification can be an entire sheet such as 8½″×11″, 11″×14″, 19″×25″ and other known sheet sizes or may be segments, divisions, strips, etc. of such sheets. For example, a 19″×25 sheet may produced with five rows of labels, with each row having six labels, with each label having dimensions of approximately 3″×4″. In this example, each row for instance may comprise an individual segment or sheet that may be used in practicing the present invention. It should however be understood that the invention is not to be so limited to the foregoing configuration and that individual pieces or elements, regardless whether the piece or elements have a regular or irregular shape, may be used in connection with this process to produce the intermediate assembly that is described in this application.

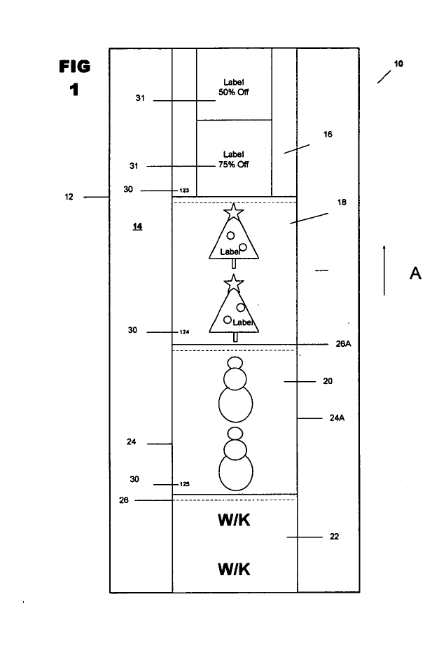

Turning now to drawings of the present invention and initially to FIG. 1. The pressure sensitive prime label intermediate web assembly is generally depicted by reference to the numeral 10. The intermediate assembly 10 includes a carrier web or continuous web 12 that has a first face 14 and a second face (not shown). The second face would be the underside of the carrier web. The continuous web 12 is preferably selected from a highly calendared, cellulosic based stock having a release coating, such as silicone. The release coating is provided on the first face 14 such that when an adhesive is applied, as will be described herein, the adhesive will transfer to the back of the label segments or sheets when the individual prime label intermediates are removed from the web. This will occur as the adhesive has a greater affinity for the label segments or sheets than for the carrier web as the label segments do not have a release coating applied to the surface in contact with the adhesive.

The web assembly 10 is advanced in a machine direction, which is designated as “A”. Machine direction for the purposes of this invention is generally intended to mean the direction in which the apparatus handles the web of material and subsequently advances the web to and through each station resident on the equipment that is used to practice the invention.

As provided in FIG. 1, the web assembly is provided with a number of prime label sheets or segments, 16, 18, 20 and 22. Each label segment has first and second sides and a first and second ends. An individual label segment is identified by reference to segment 20, in which the longitudinally extending sides are designated by 24 and 24A and the first and second ends 26 and 26A. As provided in the drawing, edge 26 is shown in phantom as it is disposed beneath label segment 22. The label segments may be placed in a substantial edge to edge configuration, which may preferably result in a slight overlap of successive label segments. Thus, edge 26 is disposed beneath the edge of the successively applied direction (again referring to the machine direction “A”). It should be understood, that while an overlap may be created, the successive label segments need not overlap one another or alternatively, the label segments may be spaced from one another.

By creating a slight overlap as described above and depicted in FIG. 1, the intermediate web assembly 10 is provided in an intermittent laminated configuration, that is, not all portions of the label segments are in full adhesive contact or fully adhered to the web 10. That is, a portion of the label segments are free of attachment to the web as well as successive label segments, that is, they are not connected to one another.

FIG. 1 is also used to show that the prime label segments 16, 18, 20 and 22 each contain different indicia images and geometric configurations. In addition to generally quadrate shapes depicted in label segment 16, label segment 18 is provided with inanimate shapes, label segment 26 with another geometric pattern that is non-quadrate and label segment 22 is provided with alpha characters “WK.” Thus, each label segment may be provided with different indicia or shapes or alternatively, it should be understood that the invention can be practiced such that each label segment may be provided with identical graphical depictions.

The unique process described in the present invention also permits the label segments 16, 18, 20, etc. to be provided with sequential numbering 30 or other indicia such as variable indicia 31 which shows a possible coupon application for CPG's. This may be accomplished in one of two fashions. In a first arrangement, the label segments are individual sheets and are prepared prior to being applied to the continuous web or carrier as will be described herein. Thus each sheet, before being provided for inclusion in the process may be printed with the variable information such as with an Indigo 3050 available from HP of Palo Alto, Calif. In the second arrangement, the sheet may be imaged after it has been applied to the web such as with an ink jet printer available from Scitex of Dayton, Ohio. with such imaging to include the personalization or application of variable data in line.

The area of overlap, if one occurs in operation of the system, is less than one inch, more preferably less than one half of one inch and still more preferably about ⅛ of an inch and yet still more preferably less than about 1/32 of an inch to about 1/64 of an inch. The area of the overlap provides a border, margin or matrix for each label that surrounds the area that will become the prime label. The area of the matrix or margin ranges between about ¼″ to about ⅛″ and more preferably about 1/32″ to about 1/64″ to compensate for the possible overlap between successive label segments or sheets. That is, no area of the prime label intermediate will encroach on another label segment and the overlap, if present, is only represented by the area of the margin or matrix. While the invention has been described in the present embodiment as having an area of overlap, it should be understood that the invention might be practiced where the edges of successive labels substantially abut one another or alternatively, there may be a slight space or gap between successive labels.

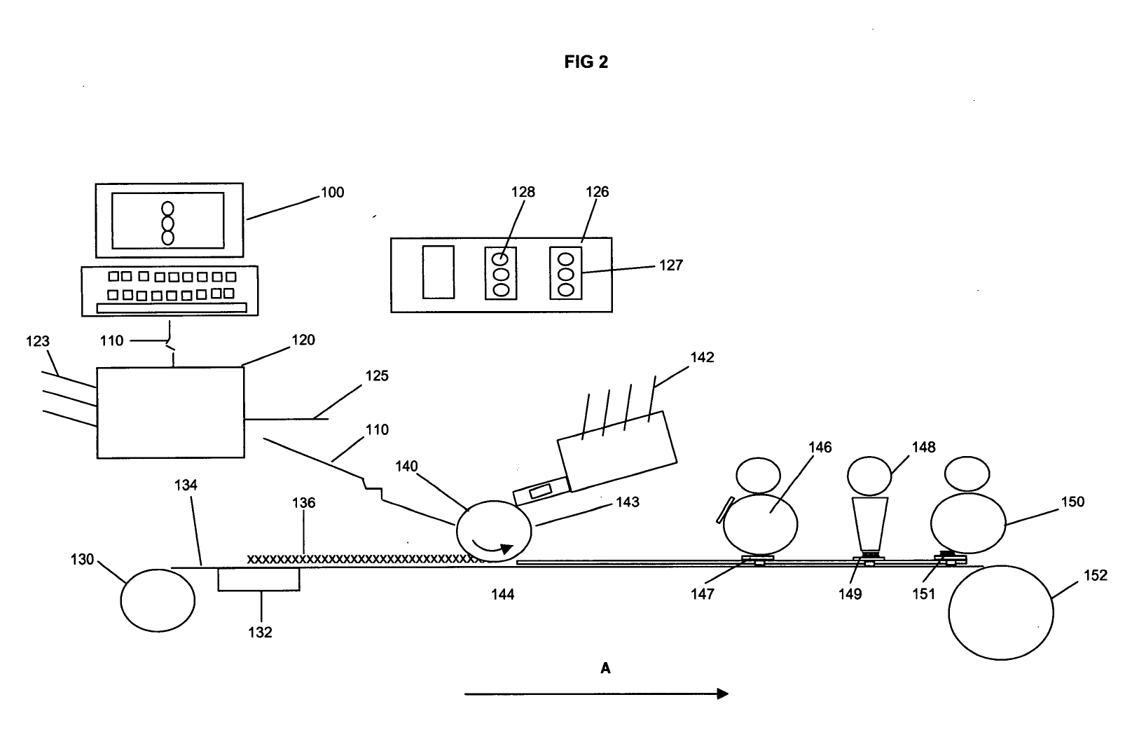

FIG. 2 presents a schematic of the present invention and includes a computer 100, such as a personal computer or “PC” that is connected via a communication means 110 to an image rendering device 120. The communication means may include a local area network, wide area network or the computer may be connected to the image rendering device via a global communications network. The communication means may also connect the imaging rendering device to the press 130 as well as the computer to the press.

The image rendering device is provided with a series of sheets 123, that are shown stacked in an in-feed hopper which are capable of receiving printing or imaging on one or both faces. The image rendering device may include such exemplary equipment as Indigo®, available from Hewlett Packard of Palo Alto, Calif. or Karat available from KBA of Williston, Vermont. The sheet 125 is sized and configured so as to be able to be processed through the rendering device such that a sheet 126 is printed with one or more label segments 127, each label segment having at least one prime label portion 128, the FIGURE illustrates three such segments, two of which are shown with printing provided by the image rendering device. Preferably, the graphics provided on the face will have a resolution of greater than about 150 lines per inch, more preferably greater than about 200 lines per inch, and still more preferably in the range of about 300 lines per inch or in the range of approximately 2500 to 3500 dots per inch

The sheet stock is provided in one of any standard sheet formats that may be used by the image rendering device. For example, one standard sheet size is approximately 19″×25″ which would permit a number of label segments to be f6rmed in the sheet. For example, each segment or ribbon may consist of six labels, with each label having a dimension of approximately 2.875″×4″. It should be understood that any standard label size might be produced as well as odd sized labels or labels having different configurations. The sheet is then cut or severed to produce individual segments 128 or strips, which are shown in the hopper or feeder mechanism at 142, with each segment having a margin or matrix which accommodates any overlap that may occur when placing the label segments on a web as will be described herein. In addition, the margin is part of the overall matrix (extra material surrounding each of the prime label segments) that will be removed after the step of die cutting to allow individual labels to be provided on the web.

The system depicted in FIG. 2 includes a web processing apparatus, generally referenced by numeral 130. The web processing apparatus may have a computer device 132 which is responsible for sequencing the operations of the press with each of the stations that may be added to the press operation.

The web processing apparatus handles a continuous substrate 134 which is provided with a release coating (not shown) and a pattern of adhesive 136, depicted as a series of“xxxx” over the release coating. The release coating is provided on the first face of the web such that when an adhesive is applied, the adhesive will transfer to the back of the label segments or sheets when the individual prime label intermediates are removed from the web. This will occur as the adhesive has a greater affinity for the label segments or sheets than for the carrier web as the label segments do not have a release coating applied to the surface in contact with the adhesive.

The carrier or continuous web is coated with a pattern of adhesive, preferably a permanent pressure sensitive adhesive, which is depicted through a series of “xxxxx”. The pattern of adhesive may be applied in a continuous format, intermittently, in a particular sequence such as lines, segments, or in any other manner which may be required to accommodate the final arrangement or configuration of the prime labels. It should, however, be understood that the adhesive may be a removable or a repositionable adhesive or be an activatable adhesive such as those that are thermally or moisture sensitive. The pattern of adhesive will have a thickness ranging from between about 0.03 mils to 3 mils, more preferably between about 0.04 mils to 1.5 mils and still more preferably between about 0.07 mils to about 1.0 mils.

Continuing with a description of the schematic presented in FIG. 2, the web processing apparatus 130 may have a number of individually operable stations that will carry out a number of operations for the web depending on the particular needs of the end user or the job that is being produced. The stations may be controlled by the computer 100 or by a separate computer.

A placer mechanism 140 is provided with a hopper which is loaded with a number of label segments 142 that were cut from sheet 126. The segments may all be of the same size or the segments may have different sizes and odd shapes including geographic, animate, and inanimate and combinations thereof. The placer mechanism feeds the label segments to a cylinder 143, e.g. a vacuum or intermediate cylinder, which places the label segments or ribbons on to the advancing web 144 in a machine direction A.

The placer mechanism is preferably activated in an incremental fashion to place label segments on the web. The placer mechanism 140 will be synchronized with the operation of the press 130, such as through a second computer and/or servo motor 132 so that the label segments are placed in a predetermined sequence over the adhesive areas 136 on the web 134.

Down stream from the placer mechanism 140 another station 146 is provided which will apply a tape strip 147 that is used to temporarily hold the prime label portions to one another as the web is advanced. The label segments may not be fully laminated or affixed to the web as there may be a small overlap between successive segments.

Still further down stream from the tape application station is a further station 148 which may be for example a station used to apply a coating or an imaging station that applies personalized or variable information which is depicted by reference numeral 149. In addition to graphical representations, raised areas, such as pseudo embossments may be created such as described in commonly assigned, co-pending application Ser. No. 10/980,347 filed Nov. 3, 2004 the disclosure of which including that found in the claims is incorporated herein by reference.

FIG. 2 also provides a further station 150 which is shown as applying a film to one surface of the continuous web at 151. It should be understood that a film can be applied to the top or bottom surfaces of the web or to both surfaces and it requires the additional application stations.

While the schematic provided in FIG. 2 shows a particular arrangement of the stations used in the present invention, the described arrangement may occur in any order, or stations may not be present or multiple stations of the same type may be added. For example, there may be multiple printing or coating stations and no film application station. It should be understood that any number of permutations are possible when configuring the system to produce a particular order or job.

At the end of the web processing apparatus 130 there is provided a rewinding apparatus 152 which collects the web with the label segments thereon in a continuous format such as continuous roll or fan folded arrangement.

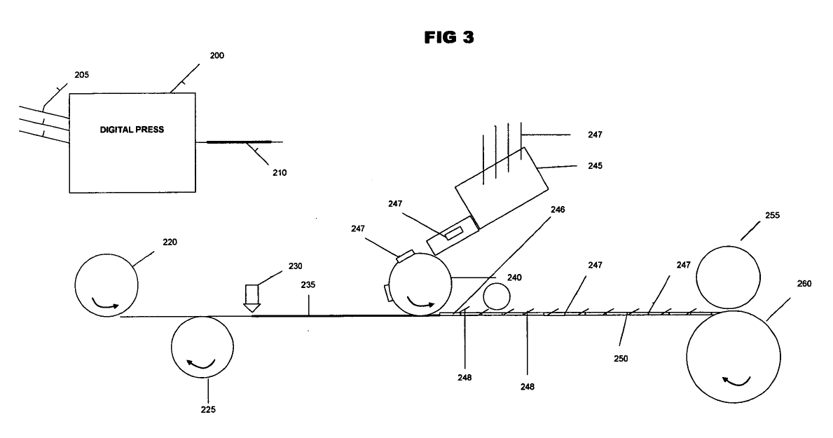

FIG. 3 provides a schematic representation of the apparatus used to carry out the present invention. Reference numeral 200 depicts a digital, sheet fed press such as an Indigo® available from Hewlett Packard Company of Palo Alto, Calif. or Karat available from KBA of Williston, Vt. The press is provided with blank sheet stock 205 and then produces an image on the stock 210, depicted by a darkened area in the drawings which is then cut into individual label segments as described above. The individual segments are then loaded into a placer or insertion device such as a Maverick® available from InLine Automation of Minneapolis, Minn. as will be described herein.

A continuous carrier web 220 is supplied from a roll and is advanced to a coating area in a machine direction “A” by machine means such as rollers or belts represented by numeral 225. The web 220 and is passed beneath an adhesive coating station 230 such as a slot coater, screen coater or other suitable means that can apply a pattern of adhesive to the web. The pattern of adhesive will generally only be the width of the label segments that are to be applied to the web.

The adhesive coated web 235 is then passed to a cylinder 240, e.g. vacuum, which is mounted beneath an insertion unit 245. Each of the pre-printed label segments 247 is passed by the inserter to the cylinder 240 and rotates around with the cylinder until it is placed on the adhesive coated web 235. The sheets 247 are placed serially and sequentially on the web so that the indicia and graphics are visible. As previously described, the label segments may preferably be placed in a slight overlapping relationship, slightly abutting or spaced from one another or a combination of the foregoing.

The label segments 247 may be temporarily joined to one another by tape strips or strings represented by numeral 248 so that when the matrix is stripped away, the tape strips will aid in holding the prime label intermediates in position and the prime labels will not be removed. The tape strips 248 are supplied from a roll 246. Alternatively, the strings or strips may be removed with the matrix.

Once the label segments have been placed on the web, the web may be advanced through additional stations, such as die cutting, 255 or coating, printing, over laminating, etc. and once the processing is completed, the intermediate web 250 is then collected such as by rewinding 260.

The label roll may then be removed to a use or application location where the individual prime labels are removed from the web and placed on containers or packages such as by a high speed label applicator.

The press speed runs at least at approximately about 50 feet per minute, more preferably between about 75 and 150 feet per minute and still more preferably at around about 200 feet per minute.

Through use of the present invention, a vast array of identifiers, e.g. labels, tags, cards, plates, etc. can be placed on an adhesive coated web and then collected for later use, thereby creating a versatile pressure sensitive intermediate web assembly. Through the use of the foregoing process a manufacturer may create innumerable high quality graphics, illustrations and variable and personalized text and indicia to create a greater impact on the potential consumer or end user. The foregoing process has a number of benefits over conventional technologies in that the process can occur at roughly equivalent press speeds and may be handled by conventional label applicators.

The present invention further fulfills the need of the small to medium range market for prime labels, those quantities typically between 100 and 1,000,000 without requiring the payment of substantial premiums as may be necessary to offset the costs associated with traditional processes such as flexographic technology.

It will thus be seen according to the present invention a highly advantageous system for producing high quality pressure sensitive products from an innovative continuous web assembly has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A system for producing prime label pressure sensitive intermediate web assemblies, comprising;
a computer for preparing an image for use in creating a graphical depiction for at least one prime label;
an image rendering device for receiving said image from said computer and for generating a pattern to create said image on said at least one prime label;
at least one sheet sized and configured to be processed through said image rendering device, said sheet is capable of being divisible into one or more label segments with each containing graphical depictions and with at least one segment containing a prime label portion;
a placer mechanism for receiving each of said label segments after said sheet is divided into individual segments;
a continuous web processing apparatus for handing a continuous substrate, said substrate having a coating of release material and adhesive applied thereto; and
wherein said placer mechanism sequentially deposits each of said label segments onto said continuous web substrate to create a pressure sensitive intermediate assembly having a series of intermittently laminated label segments.

2. A system as recited in claim 1, wherein said placer mechanism is operatively connected to said continuous web processing apparatus so that said placer mechanism is activated to incrementally position individual label segments on said continuous substrate by a sequencing device.

3. A system as recited in claim 1, wherein placer mechanism includes a hopper to individually and intermittently feed said label segments to said placer mechanism.

4. A system as recited in claim 1, wherein said system further includes a variable print head downstream from said place mechanism for adding personalized or variable information to said prime label portion.

5. A system as recited in claim 1, wherein said system further includes a tape applicator to apply a strip of tape between each of said prime label portions or segments to temporarily adhere said prime label portions to said continuous substrate.

6. A system as recited in claim 1, wherein said system further includes a film application station to apply a film to at least one face of said label segments.

7. A system as recited in claim 1, wherein said system further includes a second computer that interconnects said web processing apparatus and said placer mechanism such that said placer mechanism is in timed operational sequence with said web processing apparatus.

8. A system as recited in claim 1, wherein said image rendering device has a resolution of at least about 150 lines per inch.

9. A system as recited in claim 1, wherein said label segments may have a shape selected from a group including geometric, animate, inanimate and combinations thereof.

10. A system for manufacturing an intermittently laminated pressure sensitive label web, comprising;
an image rendering device for producing a high quality image on a series of sheets, with each of said sheets capable of being cut into one or more label ribbons and each of said label ribbons having at least one prime label area;
a continuous web feeding apparatus for handling a continuous substrate having first and second faces, first and second longitudinally extending side and first and second faces with one of said faces coated with a release material and a pattern of adhesive disposed over said release material; and
a placer mechanism mounted on said web feeding apparatus, said placer mechanism having a supply of label ribbons obtained from a pre-printed sheet and said placer mechanism sequentially places each of said label ribbons over said pattern of adhesive on said continuous substrate in a substantially edge to edge arrangement;
a die cutter disposed downstream from said placer mechanism on said continuous web feeding mechanism for creating a cut around said prime label area to distinguish said prime label area from said label ribbon; and
wherein, said label ribbons with the defined prime label portions applied to the continuous web create a prime label intermediate with a number of intermittently laminated label ribbon sections on said continuous web assembly web that may be collected in a continuous format.

11. A system as recited in claim 10, wherein said system further includes a computer for controlling operation of said web feeding apparatus and said placer mechanism so that said label ribbons are placed intermittently on said continuous web.

12. A system as recited in claim 1, wherein said system includes a communication array permitting said computer to communicate with each of said web feeding apparatus, placer mechanism and die cutter.

13. A system as recited in claim 10, wherein said system further includes a coating station to apply a coating to at least said prime label portion.

14. A system as recited in claim 10, wherein said label ribbons have a shape selected from a group including geometric, animate, inanimate and combinations thereof.

15. A system as recited in claim 10, wherein said system further includes a rewinding device downstream from said placer mechanism to collect said continuous web assembly.

16. A system for preparing a continuous pressure sensitive laminate assembly having an edge to edge configuration of prime label segments, comprising;
a design platform for creating a graphical design upon request;
a rendering device for generating an image on a substrate having one or more sections for receiving said graphical design;
a cutting mechanism for reducing said substrates into individual sections with each section having at least one pre-printed prime label portion;
a communication array for communicating between said design platform and said rendering device;
a web handling apparatus having a plurality of stations;
a placer mechanism for serially depositing each of said sections on a continuous web handled by said web handling apparatus said placer mechanism occupying one of said plurality of stations, said placer mechanism sets said sections intermittently on said web to create an intermittently laminated continuous web; and
a rewinding device downstream from said web handling apparatus for, collecting said continuous web with said individual sections disposed thereon.

17. A system as recited in claim 16, wherein said system further includes a cutting device occupying another of said plurality of stations, said cutting device defining said prime label portion from said individual sections.

18. A system as recited in claim 16, wherein said system further includes a variable printing head for adding personalized indicia to said prime label portions on said individual sections.

19. A system as recited in claim 16, wherein said system includes a coating head for applying a coating over said prime label portions.

20. A system as recited in claim 16, wherein said system produces a prime label portion having a graphical depiction having a resolution of at least about 150 lines per inch.
